(19) United States
(12) Patent Application Publication
(10) Pub. No.: US 2021/0009439 A1
(43) Pub. Date: Jan. 14, 2021

(54) A PORTABLE WATER FILTRATION DEVICE

(71) Applicant: ICON LIFESAVER LIMITED, Colchester Essex (GB)

(72) Inventor: Joseph LOVEGROVE, Colchester Essex (GB)

(21) Appl. No.: 16/977,229

(22) PCT Filed: Mar. 1, 2019
(86) PCT No.: PCT/GB2019/050575

§ 371 Date: Sep. 1, 2020

(30) Foreign Application Priority Data
Mar. 2, 2018 (GB) 1803420.7

(51) Int. Cl. C02F 1/00; C02F 1/44; C02F 1/28

(52) U.S. Cl. CPC C02F 1/002; C02F 1/444; C02F 1/283; C02F 2103/007; C02F 2303/04; C02F 2307/10; C02F 2201/006

(57) ABSTRACT

A portable water filtration device is provided. The portable water filtration device comprises a housing defining an interior volume, said housing comprising; an input port for receiving water under pressure from an external source, and; an output port having an open position and a closed position. The device further comprises; a filter comprising an an array of hydrophilic capillary fibre membranes, said filter being positioned within the housing so as to form a fluid path between the interior volume of the housing and the output port such that, in use, when the output port is in the open position, water received at the input port flows under a pressure differential induced by the external source through walls of the capillary fibre membranes to respective open ends of the capillary fibre membranes to the output port, and further wherein; the filter fills at least 65% of the interior volume of the housing.

### BACKGROUND TO THE INVENTION

Water is heavy. Delivering clean potable water over even short distances is time consuming and expensive. It requires long logistics chains or complex and expensive pipelines to maintain supplies to remote locations. This problem is evident during military or humanitarian operations, but is also relevant to communities that live in remote locations on a permanent basis.

If a person instead chooses to drink the water from the surrounding environment they run the risk of being poisoned or struck down by disease through the ingestion of bacteria, cysts or viruses living naturally in the water.

In response to this problem, WO2013/153370 discloses a bulk liquid container that is designed to provide a community with clean potable water. The container comprises a filter and is designed to store a large amount of dirty water (typically 750 litres) such that it does not need to be re-filled on an excessively regular basis. When clean water is required, the interior of the container is pressurised, typically by means of a hand pump, and the resulting pressure differential between the interior of the container and the outside atmosphere forces the stored dirty water through the filter so as to provide clean, potable water.

However, the container disclosed in WO2013/153370 is extremely large and unwieldy, which makes it difficult to transport and install, especially to remote locations. Moreover, the requirement to manually pressurise the interior of the container in order to obtain a flow of clean water is arduous and undesirable.

### SUMMARY OF THE INVENTION

In accordance with a first aspect of the invention there is provided a portable water filtration device, comprising: a housing defining an interior volume, said housing comprising; an input port for receiving water under pressure from an external source, and; an output port having an open position and a closed position; wherein the device further comprises; a filter comprising an array of hydrophilic capillary fibre membranes, said filter being positioned within the housing so as to form a fluid path between the interior volume of the housing and the output port such that, in use, when the output port is in the open position, water received at the input port flows under a pressure differential induced by the external source through walls of the capillary fibre membranes to respective open ends of the capillary fibre membranes to the output port, and further wherein; the filter fills at least 65% of the interior volume of the housing.

The present invention overcomes the problems set out in the background section by providing a portable water filtration device that is capable of providing clean, potable water. The portable nature of the device ensures that it is easy to transport to, and install in, locations where clean potable water is required, such as humanitarian or military operations, or remote communities. The device typically has a length of approximately 30 cm to 200 cm, preferably in the range of 70 cm to 100 cm and most preferably 84 cm, and as such is extremely portable and easily movable by hand.

In such situations however, it is important that a filtration device is capable of providing an acceptable flow rate of potable water to firstly ensure that enough people can be provided with potable water, and secondly to encourage users to only take filtered water when required, rather than storing clean water which is then susceptible to contamination. An acceptable flow rate is approximately 1 l/min or greater.

This requirement is met through the fact that the filter fills at least 65% of the interior volume of the housing. This rather counter-intuitively means that there is relatively little capacity to store water within the device. However, this minimises the overall size of the device (such that it is portable), whilst maximising the size of the filter within the device to ensure that an acceptable flow rate of clean, potable water is generated. In embodiments, the filter fills at least 75%, preferably at least 80%, of the interior volume of the housing.

The filter comprises an array of hydrophilic capillary fibre membranes. Dirty water is driven through the walls of the capillary fibre membranes under a pressure differential, with contaminants in the dirty water being filtered out by pores in the walls of the capillary fibre membranes. The capillary fibre membranes comprise a plurality of pores having a mean size of less than 20 nanometres, preferably less than 15 nanometres, and have a retention of greater than 99.999995% of bacteria, cysts, parasites and fungi, and greater than 99.999% of viruses from the dirty water. The fibre membranes also remove sediments and other deposits from the water.

A preferred material for the hydrophilic capillary fibre membranes is polyethersulphone.

As explained above, the water is filtered by driving it through the walls of the capillary fibre membranes under a pressure differential. However, the water filtration device of the present invention preferably does not comprise pressurisation means. It has been found that existing water sources such as harvested rainwater tanks and mains water supplies may provide the required pressure differential to drive dirty water from these sources through the capillary fibre membranes. In the case of a (non-potable) mains water supply, the water may already be under pressure. A rainwater tank elevated at a height above the filtration device has been found to provide sufficient head pressure to drive the water through the filter. For example, a tank positioned 2m above the height of the filter provides a pressure of approximately 20 kPa (0.2 bar), which is sufficient to generate a flow rate through the filtration device of approximately 5 l/min. Water pumped from boreholes, reservoirs, lakes, rivers, wells or other suitable water sources may also be supplied to the filtration device under pressure in order to generate the required pressure differential. It is envisaged that such pumping would be performed by a pump external to the water filtration device.

The absence of pressurisation means further increases the portability of the device by reducing its overall size and weight. Furthermore, this allows for a more robust filtration device compared to conventional containers whose pressurisation mechanisms may become damaged in transit or by misuse. The absence of pressurisation means also enables maximisation of the filter size within the device in order to ensure an acceptable flow rate of potable water.

As above, the water filtration device preferably does not comprise an (e.g. integrated) pressurisation means (such as a pump). This means that the pressure differential for driving water along the fluid path through the walls of the capillary fibre membranes is induced only by pressure from the external source.

It is envisaged that the portable water filtration device will be transported to a location where clean drinking water is required, installed and connected to an external water source capable of providing the required pressure for filtration. As above, examples of external water sources (i.e. water sources that are separate to the water filtration device) are a non-potable mains water supply, rainwater harvesting tanks located at a height, and water pumped by an external pump from boreholes, reservoirs, lakes, rivers, wells etc.

Preferably, the housing is elongate in a first direction. The filtration device is typically installed with its elongate direction parallel to the surface on which it is installed (i.e. “horizontally” installed). This gives the device a low profile height which is advantageous when using an elevated rainwater tank as the external water source, for example, as this maximises the generated head pressure.

As explained above, water is driven through the walls of the capillary fibre membranes under a pressure differential, with contaminants in the dirty water being filtered out by pores in the walls of the capillary fibre membranes. The filtered water then flows along the capillary fibre membranes to the respective open ends and out through the output port. Dirty water can thus be filtered at any position along the length of a capillary fibre membrane.

Particularly advantageously, the capillary fibre membranes may be elongate, with the capillary fibre membranes and the housing being elongate in the same direction. As the capillary fibre membranes are elongate in the same direction as the housing, this maximises the surface area of the capillary fibre membranes that may be in contact with dirty water within the housing, thereby resulting in increased flow rate of water through the device.

In preferred embodiments the housing is substantially cylindrical. Such a cylindrical geometry is not only elongate, but is also resistant to deformation under the internal pressure of the filtration device. Preferably, the end faces of the housing have a curved form (for example substantially hemispherical or torispherical) to further resist deformation. A housing having substantially cylindrical form with curved end faces may be described as having a capsule geometry.

However, other housing geometries are envisaged, such as spherical, conical or cuboidal.

The housing defines an interior volume. Water may be contained within the (e.g. sealed) interior volume of the housing and as such the outer surface (or “wall(s)”) of the housing (extending between any ports or other features as described herein) are preferably substantially continuous (i.e. do not comprise holes or orifices) and made of a material that is impermeable to water. Preferred materials are discussed hereinbelow.

The housing may comprise strengthening ribs to aid against deformation due to the internal pressure within the device. Such strengthening ribs preferably extend around the outer surface of the housing.

The housing may beneficially further comprise a bleed valve operable to remove air from the interior volume of the housing. When water is provided to the interior volume of the housing through the input port, the bleed valve may be moved to an open position such that air that was originally within the housing may flow out through the bleed valve. This removal of air advantageously allows more water to be temporarily stored within the housing surrounding (“submerging”) the filter. This maximises the amount of water in contact with the capillary fibre membranes of the filter, thereby maximising the flow rate of water through the device.

The bleed valve is preferably located in a top part of the housing, most preferably the topmost part. The bleed valve is preferably located in a top part of the housing, most preferably the topmost part, when the filtration device is in a “horizontally installed” configuration.

In preferred embodiments, the housing comprises a drainage port located below the input port, the drainage port having an open position and a closed positon. When water is desired to be filtered, the drainage port is in the closed position such that the interior volume of the housing is sealed and the requisite pressure differential across the walls of the capillary fibre membranes can be established. However, when the drainage port is in the open position, water entering the housing through the input port will flow through the housing and out of the drainage port. This flow of water advantageously rinses the outer surface of the filter membranes such that sediment and debris that may have been previously filtered is washed away from the filter. This prevents “clogging” of the filter to ensure that an adequate flow rate is maintained. This also advantageously prolongs the life of the filter.

The drainage port is located “below” the input port when the water filtration device is in its installed configuration (preferably when “horizontally” installed). In other words, the drainage port and input port are positioned such that water may flow under gravity from the input port to the drainage port.

Preferably, the drainage port is located at the substantially lowest part of the housing (e.g. when the water filtration device is in its horizontally installed configuration) to encourage water flow out of the drainage port when it is in the open position.

The filter is typically removably positioned within the housing. This allows a user to replace the filter when necessary (preferred filters typically provide an estimated 250,000 litres of potable water before they require replacing). To gain access to the filter, the housing typically has a removable end cap. Typical interfaces between the removable end cap and the remainder of the housing include screw-threads and push-fit interfaces that are capable of sealing the interior volume of the housing. The filter is preferably a cartridge filter for ease of replacement and installation. The interior of the housing may have connection means for securely receiving the filter, for example.

In other embodiments, the housing of the filtration device may be formed as a unitary member such that the filter is not removable. This may ensure that users do not inadvertently contaminate the filter, for example.

The housing may further comprise a second input port for receiving water under pressure from an external source. For example, the first input port may be connected to a rainwater harvesting tank, and the second input port may be connected to a mains supply of water. This ensures that the filtration device will always be able to receive water under pressure so as to generate clean potable drinking water. However, a particularly advantageous result of a second input port is that a plurality of such filtration devices may be linked together via connection means (such as a hose) connected between input ports of different devices. In this manner, a plurality of devices may each be in fluid communication with the water source, and each provide clean, potable water. This beneficially allows for increased flexibility in the way in which the devices may be installed and used.

The portable filtration device may comprise mounting means for (e.g. securely) mounting the device. Such mounting means may comprise legs positioned on a bottom side of the housing arranged for mounting the device stably on a surface. The legs and housing may be formed as a unitary member, or provided as separate parts. Alternatively or in addition, the mounting means may comprise at least one recess and/or loop arranged for receiving a strap or rope such that the device may be hung.

The filtration device may comprise a carry handle for ease of transportation.

The output port preferably comprises a tap, although other suitable ports having an open position and a closed position may be used, such as a nozzle.

The housing may further comprise a pressure regulator adapted to prevent the pressure in the device being raised above a predetermined level. This not only ensures the safety of the user but also increases the longevity of the equipment. Typically the pressure regulator is automatically actuated upon the internal pressure within the housing exceeding a predetermined level (this may be sensed by a suitable pressure sensor for example).

Preferably the pressure regulator comprises a valve, which in some embodiments may be the bleed valve. Preferably the pressure regulator comprises a spring rated device where the spring rate sets the pressure within the housing at which the valve opens (i.e. when the pressure within the housing reaches a predetermined level). The valve then re-seals automatically when the pressure within the housing drops below the predetermined level. Other suitable pressure regulators may be used however.

As outlined above, the filter is positioned within the housing so as to form a fluid path between the interior volume of the housing and the output port. Dirty water from the interior volume of the housing flows along the fluid path such that clean, potable water flows out of the output port. In embodiments, the fluid path may comprise a secondary filter located between the filter and the output port.

Such a secondary filter is typically a carbon filter, preferably an active carbon filter, although other types of carbon-based filters (such as charcoal filters) may be used. Carbon filters are known to be effective in the removal of chemicals and heavy metal contaminants from water, as well improving taste and odour. Alternatively, or indeed additionally, different filters could be incorporated into the filtration device. For example, resin filters are known as effective desalinisation filters. Filters of this or other types may be incorporated into the primary filter itself.

Secondary carbon filters are generally used in “on-grid” set-ups where the external water source is a mains supply, for example. Such water supplies are typically chlorinated and the carbon filter acts to remove undesirable taste due to chlorine. In “off-grid” set-ups (e.g. the external water supply is from harvested rainwater or a borehole), a secondary carbon filter may not be used.

Preferably, such a secondary filter is removable from the filtration device, allowing it to be replaced. It is envisaged that the secondary filter is removable separately to the primary filter, which advantageously prevents contamination of the primary filter (for example by dirty fingers).

Preferably at least one of the housing and output port is constructed from plastic materials, preferably water-grade acrylonitrile butadiene styrene (ABS), polypropylene or medium- or high-density polyethylene (HDPE). Typically the output port will be constructed from ABS or polypropylene, and the housing will be constructed from HDPE. The housing is preferably blow-moulded. Preferably, at least the output port comprises an anti-microbial additive in order to restrict the growth of bacteria, fungi and mould. Typically, any feature of the filtration device that comes into contact with clean filtered water comprises such an anti-microbial additive.

In accordance with a second aspect of the invention there is provided a water filtration system comprising: a portable water filtration device according to the first aspect; an external water source, and; connection means adapted to connect the external water source to the input port of the water filtration device such that water under pressure is provided to the water filtration device from the external water source. The connection means is typically a hose. The water filtration system may further comprise a filter positioned between the external water source and the portable water filtration device. This filter is typically a coarse filter configured to remove coarse particles of sediment and debris (that may have been collected in a rainwater harvesting tank for example) before reaching the filtration device.

In embodiments, the system may further comprise a plurality of portable water filtration devices having at least two input ports, wherein said plurality of water filtration devices are connected together by connection means such that each device is in fluid communication with the external water source and water under pressure is provided to each device from the external water source.

In accordance with a third aspect of the invention, there is provided a kit comprising a portable water filtration device according to the first aspect, and a hose attachable to the input port.

In accordance with a fourth aspect of the invention, there is provided a computer program product encoding 3D printing instructions to manufacture, using a 3D printer, the portable water filtration device of the first aspect. A variety of 3D CAD file types may be used for such 3D printing and/or modelling of the device, for example STEP files. The CAD file may be converted into instructions a 3D printer can action.

### BRIEF DESCRIPTION OF THE DRAWINGS

The invention will now be described with reference to the accompanying drawings, in which:

FIG. 1a illustrates a side view of a portable water filtration device according to the invention;

FIG. 1b illustrates an end view of a the portable filtration device;

FIG. 2 is a cross-sectional view of the portable filtration device;

FIG. 3 is a schematic diagram illustrating the portable filtration device connected to an external water source in use;

FIG. 4 schematically illustrates a plurality of portable filtration devices linked together;

FIGS. 5a and 5b illustrate a portable water filtration device according to the invention;

FIG. 6 shows a preferred filter for use in the filtration device of the present invention, and;

FIG. 7 illustrates a cut-away section of a filter for use in a preferred embodiment the present invention.

### DETAILED DESCRIPTION

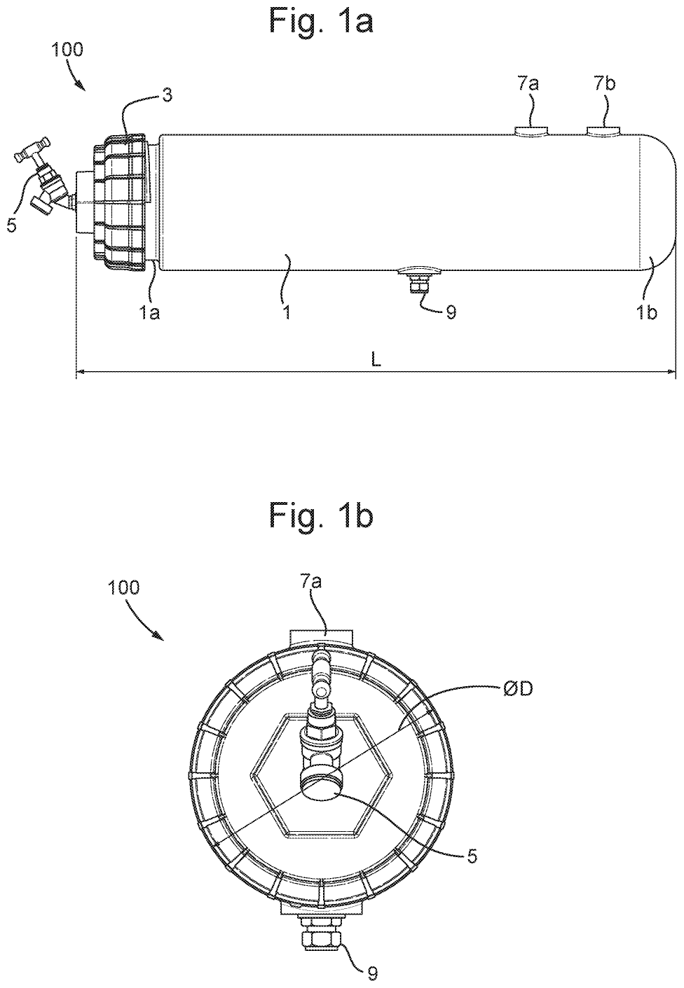

FIG. 1a illustrates a side view of a portable water filtration device 100 according to the invention. The filtration device 100 comprises an elongate, hollow, substantially cylindrical, main body 1 that defines an interior volume. The main body 1 has an open first end la and a permanently sealed second end 1 b. As can be seen in FIG. 1, the second end 1 b has a curved form and in some embodiments may be hemispherical or torispherical in geometry.

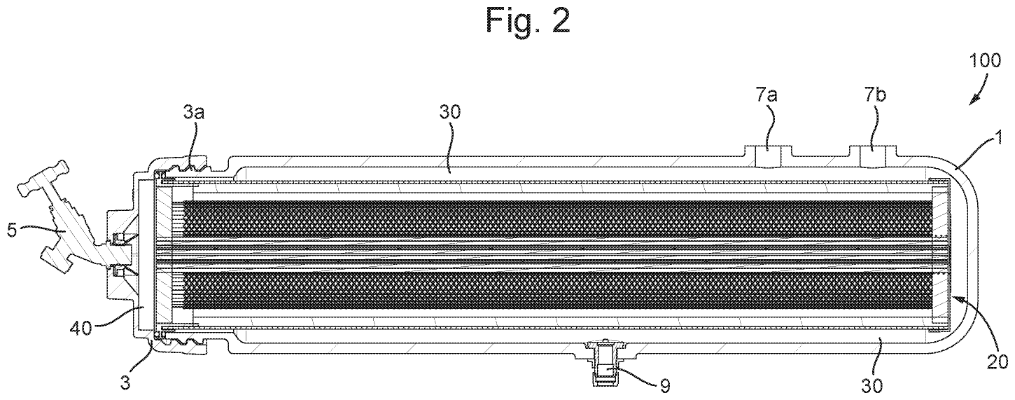

The first end 1a of the main body 1 is sealed by a removable end cap 3 so as to create a sealed interior of the filtration device. The main body 1 and end cap 3 together form a housing of the filtration device 100. The end cap 3 is removably attachable to the first end 1 a of the main body 1 by means of a screw thread interface (shown at 3a in FIG. 2), although other means of attaching the end cap 3 to the main body 1 are envisaged as would be known to those skilled in the art, such as a push-fit interface. The end cap 3 comprises an output port 5 having an open position and a closed position. In this embodiment, the output port is a tap.

The length, L, of the water filtration device (excluding the output port) is in the range of approximately 30 cm to 200 cm, preferably in the range of 70 cm to 100 cm and most preferably 84 cm. The cross-sectional diameter, D, of the device (as seen in the end-on view of FIG. 1b) is in the range of approximately 10 cm to 25 cm, preferably in the range of 15 cm to 20 cm and most preferably 19 cm. These dimensions ensure that the water filtration device 100 is portable and easily transportable.

The substantially cylindrical form of the main body 1, together with the curved form of the second end 1b, advantageously means that water and air are able to be stored under pressure within the filtration device without substantial deformation of the main body.

The main body 1 comprises first 7a and second 7b input ports, and a drainage port 9 located at an underside portion of the main body. Each of the input and drainage ports have an open position and a closed position, and will be explained further below.

FIG. 2 is a cross-sectional view of the filtration device 100, and illustrates a filter 20 comprising an array of elongate hydrophilic capillary fibre membranes. The filter is typically provided as a filter cartridge. The filter cartridge 20 is substantially cylindrical in shape and fits into the interior volume defined by the main body 1. With the filter cartridge 20 inserted into the main body 1, a reservoir 30 is defined within the main body 1 surrounding the filter 20. The reservoir is substantially annular is cross-section. Water within the reservoir 30 in contact with the fibre membranes of the filter 20 may pass, under a pressure differential, through pores in the walls of the fibre membranes, along their respective lengths to respective open ends proximal to the tap 5. Advantageously, water may therefore be filtered at any position along the length of the filtration device.

The fibre membranes are elongate in the same direction as the long axis of the main body 1, which advantageously means that the surface area of the fibre membrane walls in contact with water within the reservoir 30 is maximised. This ensures good flow rate of water through the filter (typically at least 51/min).

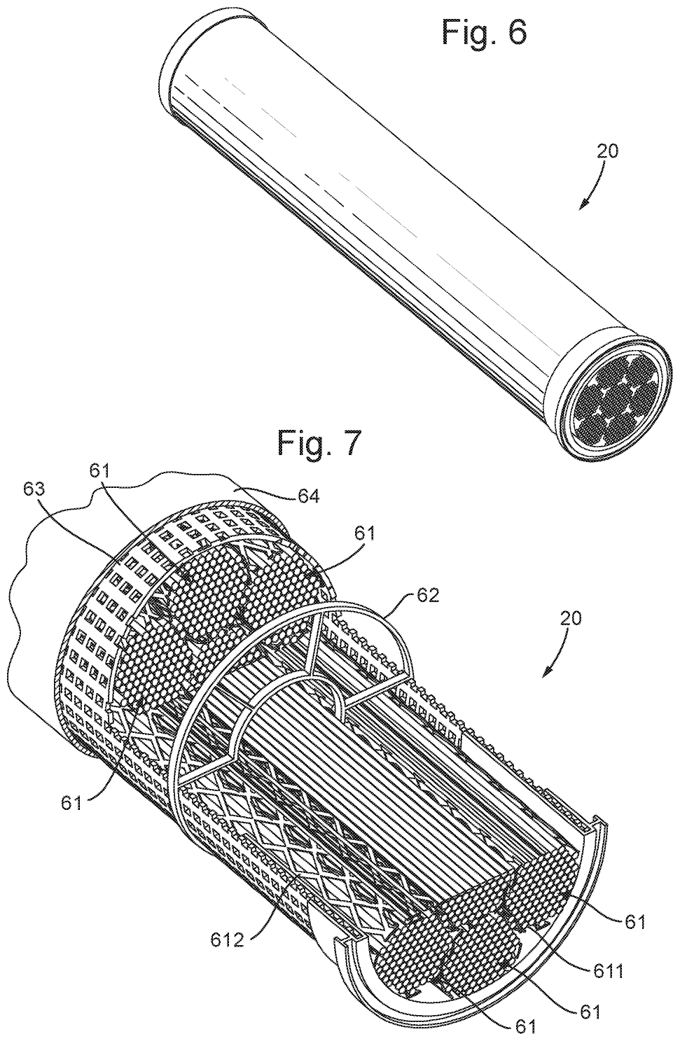

The structure of the filter cartridge 20 will be described in more detail with reference to FIGS. 6 and 7.

The filter 20 takes up at least 65%, preferably at least 75% and most preferably at least 80% of the internal volume of the housing (as defined by the main body and end cap). The filtration device 100 therefore has minimal storage capacity (relative to the size of the whole device) within reservoir 30, and is designed to allow a high rate of water throughput when connected to an external water source.

The filter 20 may be inserted and removed from the main body 1 through the first end 1a when the end cap 3 is removed. This advantageously allows the filter to be replaced when required. Preferred filters typically provide an estimated 250,000 litres of potable water before they require replacing. In other embodiments, the end cap 3 may not be removable and the housing is provided as a unitary member.

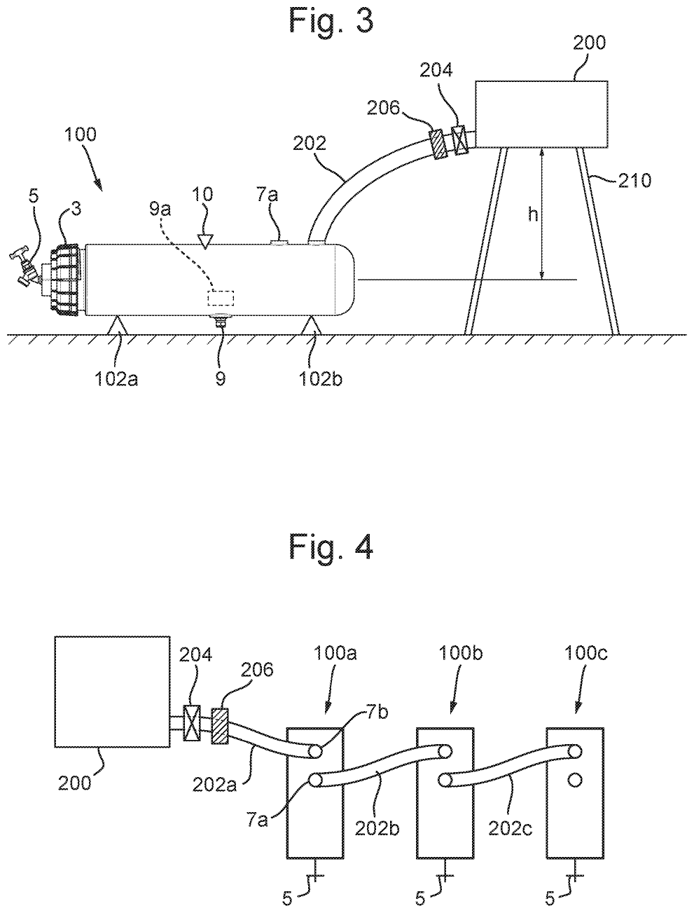

In order for water to pass from the reservoir 30 through the fibre membranes of the filter cartridge 20, a pressure differential must be generated across the walls of the fibre membranes. The filtration device 100 does not comprise pressurisation means, and FIG. 3 schematically illustrates a suitable arrangement for generating such a pressure differential.

As illustrated in FIG. 3, a harvesting tank 200 is supported by stand 210 at a height h above the top of the filtration device 100 (more specifically a height h above the height of the filter 20). The harvesting tank 200 has a volume of water (for example harvested rainwater) that is desired to be filtered to potable quality and consumed. A hose 202 is connected between the harvesting tank 200 and an input port (in this case second input port 7b) of the filtration device 100. Any other ports (here first input port 7a and drainage port 9) are in their closed position such that the interior of the filtration device 100 is sealed. A valve assembly 204 such as a tap may be used to control the flow of water from the harvesting tank 200 to the filtration device 100.

The input ports 7a, 7b are typically standard threaded ports.

In use, water is allowed to flow from the harvesting tank 200 into the reservoir 30 of the filtration device 100 along hose 202, with the tap 5 in its closed position. More specifically, water flows into reservoir 30 of the main body interior such that the water is in contact with the fibre membranes of the filter 20. The height of the harvested water in the tank 200 provides a water pressure of pgh, where p is the density of the water, g is the acceleration due to gravity and h is the height of the harvested water above the filter. This head pressure generates a pressure differential between the sealed interior of the filtration device and the external atmosphere.

When the tap 5 is moved to the open position, water stored in the reservoir 30 is driven by this pressure differential through the walls of the capillary fibre membranes to respective open ends of the capillary fibre membranes and out of the tap 5. Water will continue to flow through, and be filtered by, the filtration device 100 due to the head pressure induced by the harvesting tank. This means that the filtration device 100 does not require substantial storage capacity, or pressurisation means. Instead, the filtration device 100 of the present invention is portable and may be used to generate clean, potable water in locations where an external water source may provide the required pressure differential.

The example provided in FIG. 3 is in relation to a harvesting tank which may typically already be installed in the location of interest. Alternatively or in addition, the filtration device 100 may be connected, via first and/or second input port, to a mains water supply that is capable of providing a sufficient pressure differential such that water is driven from reservoir 30, through filter 20 and out through the tap 5. Other external water sources may be utilised, for example bore holes, rivers, reservoirs and wells where pumps may be used to provide the water under pressure.

Two input ports 7a, 7b have been shown in the examples so far. This advantageously allows two or more filtration devices to be linked together and be in fluid communication with one water source. Such an arrangement is schematically illustrated in FIG. 4, where three filtration devices 100a, 100b, 100c are linked to harvesting tank 200. As in FIG. 3, a hose 202 connects the harvesting tank 200 to the second input port 7b of first filtration device 100a. As shown in FIG. 4, a hose 202b is attached between first input port 7a of first filtration device 100a and a first input port of second filtration device 100b. Similarly, a hose 202c is connected between a second input port of second filtration device 100b and a first input port of third filtration device 100c. If the taps 5 of each filtration device are closed, water from the harvesting tank may flow through the hoses such that water surrounds the filters in the filtration devices. Subsequently, the head pressure from the harvesting tank provides sufficient head pressure to drive water through the filter of each filtration device once the respective tap is open. In this manner, a plurality of filtration devices may advantageously provide clean, potable water.

Although three filtration devices are illustrated in FIG. 4, two devices, or more than three devices, may be linked in such a manner.

Alternatively or in addition, the ports 7a, 7b may be connected to two harvesting tanks, or one connected to a harvesting tank and one to a mains water supply, such that there will always be a source of pressurised water available to the filtration device 100. Filtration devices comprising one input port, or three or more input ports, are envisaged.

As seen in FIG. 3, the filtration device 100 may optionally comprise a bleed valve 10, located in a top portion of the main body 1. The bleed valve 10 has an open position and a closed position. When the filtration device 100 is connected to an external water supply that supplies water under pressure, a user is able to move the bleed valve 10 to the open position in order to let air within the internal volume of the main body 1 escape (i.e. “bleed” the filtration device). This is not essential, but doing so advantageously allows an increased volume of water into reservoir 30, which consequently increases the flow rate of water through the filtration device as more water is in contact with the fibre membranes of the filter 20.

The bleed valve 10 may also act as a safety pressure release valve, and may be operable to automatically open when the pressure within the filtration device 100 reaches a predetermined threshold value. In such an instance the filtration device 100 comprises a spring rated pressure regulation device, where the spring rate is set such that the bleed valve 10 opens when the pressure within the main body 1 reaches a predetermined level. Once the pressure drops below the predetermined level, the bleed valve 10 automatically closes.

The drainage port 9 has an open position and a closed position. When the filtration device 100 is being used to filter water, the drainage port is in its closed position such that the internal volume of the filtration device 100 is sealed and the requisite pressure differential is generated. However, when the drainage port is in the open position, water provided to the filtration device 100 through one of the input ports will simply flow from the input port to the drainage port 9, rather than through the fibre membranes of the filter. This flow of water advantageously rinses the outer surfaces of the fibre membranes, removing any debris or sediment that may have previously been filtered out by the pores of the membranes and has settled on the filter. Rinsing the outer surfaces of the membranes in this manner prevents the filter from getting “clogged” with debris or sediment, thereby maintaining a suitable flow rate through the filter, and prolonging the life of the filter.

If the filtration device 100 is mounted off the ground (as seen in FIG. 3), the drainage port 9 is preferably located at the lowest point on the main body 1 (as seen in FIGS. 1-3), as this location allows the greatest amount of dirt, solids or sediment to be flushed from the device. If the device 100 is not mounted off the ground, the drainage port may be located away from the lowest point (as illustrated at 9a in FIG. 3) such that the drainage port does not foul the ground. In general, the drainage port is located below the level of the input port(s) such that water is able to flow under gravity from the input port(s) to the drainage port in order to flush out the filtration device.

A sediment pre-filter, shown schematically at 206 in FIG. 3, may be located between the external water source and the filtration device in order to remove coarse-size particles of dirt and sediment before reaching the filtration device, and therefore minimise the clogging of the filter membranes with dirt and sediment.

Referring to FIG. 2, a space 40 is defined within the filtration device 100 between the filter cartridge 20 and the tap 5. A secondary filter (not shown) may be positioned within this space 40 such that water passes through the filter cartridge 20, through the secondary filter and then out through the tap 5.

Due to the minimal relative storage capacity of the filtration device 100, it may be easily transported to a suitable location and connected to an external water source. In some embodiments, the filtration device 100 may comprise a carry handle to aid transportation. When in the desired location, the filtration device is typically mounted in a stable manner to prevent undesired movement, and preferably spaced from the ground, particularly when the drainage port 9 is located at the lowest point on the main body 1.

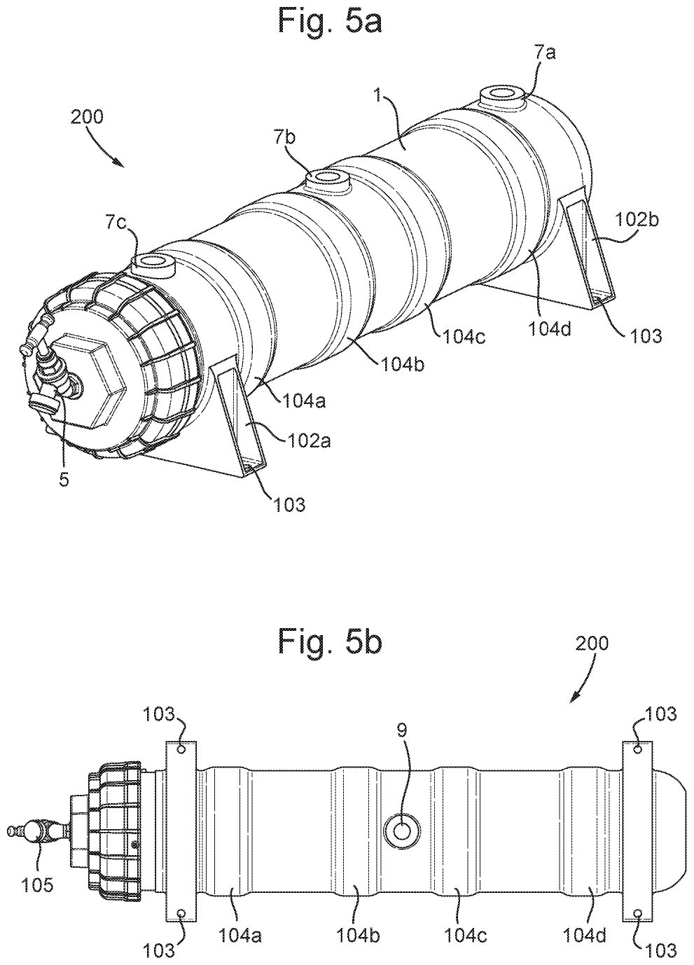

FIG. 5a illustrates a further example filtration device 200 according to the invention. The device 200 in FIG. 5a is mounted on spaced apart feet 102a, 102b such that the main body is spaced from the ground (as in FIG. 3). The feet 102a, 102b may be integrally moulded with the main body or may be provided as separate parts. The feet may comprise screw holes 103 (more clearly shown in FIG. 5b) that allow for secure fixing of the feet if desired. In such an instance it is desirable that the feet and filtration device are provided as separate parts such that the device may be removed from the feet, e.g. for cleaning purposes.

The main body 1 seen in FIG. 5a also comprises a plurality of strengthening ribs (shown at 104a, 104b, 104c, 104d) extending around the outer surface of the main body, and acting to increase the stiffness of the main body in order to resist deformation due to the internal pressure. Although four ribs are illustrated in FIG. 5a, more than four, or fewer than four, such ribs may be used.

As an alternative to mounting using feet 102a, 102b, the device may be hung (e.g. from a tree or ceiling) by straps or ropes. The gaps between adjacent strengthening ribs advantageously provide suitable recesses for placement of such straps such that they do not foul the input ports. A rope (or other suitable material) carry handle could be attached between the strengthening ribs. Hanging loops attached to the main body (not shown) are also contemplated.

The filtration device 200 seen in FIG. 5a comprises three input ports 7a, 7b, 7c to provide further flexibility in the set-up of such a device (e.g. linking to other devices as described above).

The filter cartridge 20 will now be described in more detail with reference to FIGS. 6 and 7.

FIG. 6 shows a preferred filter cartridge 20 for use in the water filtration device of the present invention. It may be used in the invention and located as illustrated by filter 20 in the previous figures. The filter may be substantially cylindrical in shape and as described above may fit into the interior volume of the main body 1.

Preferred water filters for use with the present invention are suitable for ultrafiltration: that is to remove all particles of a size greater than 0.01 microns. In another preferred embodiment the filter is suitable for nanofiltration or reverse osmosis. Reverse osmosis filters are capable of removing everything (including salts and oils) apart from pure water (H₂O) from a liquid. Nanofiltration removes particles of a size greater than 0.001 microns (including aqueous salts).

Water is passed through the water filter under a pressure differential. This allows the water to be passed through finer filters than would be possible if the filtration device 100 were not pressurised.

A pore size of less than or equal to 25 nanometres is sufficient to remove most microbiological matter from the water, including viruses, thereby providing safe drinking water. However, for additional security, in preferred embodiments of the invention, the filter has a pore size of less than or equal to 20 nanometres, and more preferably have a pore size of less than or equal to 15 nanometres.

As is known in the art, the pore size of a material is in fact an average of the individual sizes of the pores (or holes) in the material, since it is inevitable that any material comprising a large number of pores will include some variation in these individual sizes. Preferred filters for use in the present invention have a tightly defined distribution of pore sizes such that the difference between the maximum pore size and the average pores size is minimized. Preferably, the standard deviation of the pore size distribution is less than 30% of the average pore size, and more preferably is less than 15% of the average pore size. In preferred embodiments of the invention, the filter has a maximum pore size of less than or equal to 30 nanometres, more preferably less than or equal to 25 nanometres, even more preferably less than or equal to 20 nanometres and most preferably less than or equal to 15 nanometres. In other embodiments, the maximum pore size may be even lower in order to perform nanofiltration or reverse osmosis, for example.

Preferably, the filtration device of the present invention will filter water with a pressure differential of any size. For example, the operating pressure differential of a preferred embodiment is preferably greater than 5 kPa (0.05 bar), more preferably in the range of 10 kPa (0.1 bar)-300 kPa (3 bar), even more preferably in the range of 50 kPa (0.5 bar)-100 kPa (1 bar). The large surface areas used in the filter of the present invention allow for a greater flow rate for a given pressure differential across the filter or between the reservoir-side of the filter and the ambient pressure of the surrounding environment. Thus the filtration device of the present invention can be used at lower pressures than smaller hand-held containers while still achieving a satisfactory flow-rate through the filters. As described above, the system is sealed so as to allow a pressure differential between the inside of the filtration device and the outside atmosphere to be created to drive water through the filter and out of the tap when opened.

The water filter of the present invention is preferably a membrane filter and comprises an array of hydrophilic capillary fibre membranes. Hydrophilic membranes are attractive to water and therefore water is passed through them in preference to other liquids and to gases. In this way, not only is the filtration offered by the preferred embodiments improved, but it is possible to use the filter even when it is not completely immersed in the water.

Preferably, the membranes are capillary hollow fibre membranes. These membranes act to filter the water as only particles smaller than their pore size may pass through them. The fibre membranes may incorporate carbon or other chemical elements, or reverse osmosis membranes. A combination of different types of filter membranes may be included in the filter. These may include ultrafiltration, nanofiltration and reverse-osmosis membranes.

In a preferred embodiment, the water filter comprises a filter cartridge comprising a plurality of fibre membranes. Preferably, the interior of the main body 1 of the filtration device 100 incorporates a seat to receive the filter cartridge to resist lateral movement. This helps reduce the strain on the preferred fibre membranes.

Once water enters through the wall of a hollow fibre membrane under the influence of a pressure differential, it is transferred along its tube-like structure to the output.

As a result, water may enter at any point along the membrane wall and reach the output while also being filtered.

The preferred fibre membranes have a retention of greater than 99.999995% of bacteria, cysts, parasites and fungi, and greater than 99.999% of viruses from the water. The fibre membranes also remove sediments and other deposits from the water.

Fibre membranes suitable for use with the present invention are available commercially, for example from SUEZ Water. The hollow fibre ultra-filtration membranes are effective to screen all turbidity, bacteria as well as viruses.

In a preferred embodiment of the filtration device 100, the length of the preferred fibre membranes is between 30 to 200 cm, preferably 80 cm. For such lengths in the device of the present invention, the preferred filter cartridge incorporates 600 to 800, preferably 650 to 700, fibre membranes, giving an initial flow rate of between 5 to 10 litres/minute, which may be achieved at a pressure differential across the filter of between 10 and 50 kPa (0.1 to 0.5 bar). Each of seven bundles of fibres in the filter cartridge 20 may comprise 96 individual fibres. It is important to provide a reasonable flow rate to encourage users to take filtered water from the filtration device when required, rather than transfer filtered water to a different container for storage, where it would quickly become contaminated. Advantageous flow rates may be achieved where the total surface area provide by the filter membranes is in the region of 3 m² to 6 m², preferably around 4.6 m².

In FIG. 7 a cut-away section of a filter cartridge 20 for use in a preferred embodiment the present invention is illustrated. The filter cartridge has a plurality of sub-groups (“bundles”) 61 of filter membranes 611. Each sub-group 61 in the example illustrated has 96 filter membranes 611, however, useful numbers of filter membranes per sub-group can be in the range of 80 to 100 filter membranes per sub-group. Each sub-group may be surrounded by a sheath 612 for holding the sub-group together in a single bundle. This can prevent damage during assembly and hold the sub-group together for increased structural integrity. The sheath 612 may be constructed of a mesh or net or polynet or other rigid or resilient water-penetrable material.

The filter membranes 611 may be bundled in further groups of seven within each subgroup 61 as illustrated. This configuration allows some spacing to be kept between adjacent membranes, which makes efficient use of space in the filter while allowing a sufficient flow-area for water to reach the membranes and establish the required flow-rate through the filter.

A spacer (shown at 62) is optionally provided in between sub-groups 61 of filter membranes 611. The spacer may have a central circular or hexagonal portion surrounding a central sub-group and a series of spokes protruding substantially radially from the central portion such that spacing is maintained in between adjacent sub-groups 61 of filter membranes 611. A plurality of spacers may optionally be provided at plural axial locations along the length of filter cartridge 101 to provide support and spacing relatively evenly along the length of the filter cartridge.

Surrounding the filter membranes is an outer structural member 63 in the form of a substantially cylindrical grid-patterned or mesh-like structure, which may comprise a structure through which water can penetrate to reach the filter membranes 611, while maintaining a structural support around the filter membranes 611.

Around the structural member 63 is a primary filter here illustrated in the form of an outer filter mesh 64, which acts as a primary filter to prevent silt, dirt and sediment from contacting the filter membranes 611 inside the structural member 63. Filter mesh 64 may be made from cloth or other fibrous material or from a fine plastic mesh having an opening size of around 100microns. The outer filter mesh 64 may comprise activated carbon.

The fibre membranes 611 may be potted at an open end proximal the tap 5 and sealed and capped at a distal end thereto. A mesh wrap helps hold the fibre membranes together. In a configuration where the filtration device has taps or valves on opposite sides, and/or taps or valves are arranged at opposite ends of a filter cartridge 101, (for example the filtration device 100 may further comprise an output port at second end 1 b of the main body), the fibre membranes 611 may not be capped, but may be open at both ends, such that water entering the fibre membranes 611 can be delivered to either one of the taps or valves at either end of the filter cartridge 101.

1-33. (canceled)

34. A portable water filtration device, comprising:
a housing defining an interior volume, said housing comprising; an input port for receiving water under pressure from an external source;
a filter comprising an array of hydrophilic capillary fibre membranes;
a reservoir surrounding the filter, and;
an output port having an open position and a closed position; wherein the device further comprises;
the filter being positioned within the housing so as to form a fluid path between the reservoir and the output port such that, in use, when the output port is in the open position, water received at the input port flows under a pressure differential induced by the external source through walls of the capillary fibre membranes to respective open ends of the capillary fibre membranes to the output port, and further wherein;
the filter fills at least 65% of the interior volume of the housing.

35. The device of claim 34, wherein the filter fills at least 75%, preferably at least 80%, of the interior volume of the housing.

36. The device of claim 34, wherein the housing is elongate in a first direction, and preferably wherein the capillary fibre membranes are elongate, and wherein the capillary fibre membranes and the housing are elongate in the same direction.

37. The device of claim 34, wherein the housing is substantially cylindrical.

38. The device of claim 34, wherein the housing further comprises a bleed valve operable to remove air from the interior volume of the housing.

39. The device of claim 34, wherein the housing further comprises a drainage port located below the input port, the drainage port having an open position and a closed position, preferably wherein the drainage port is located at the substantially lowest part of the housing.

40. The device of claim 34, wherein the filter is removably positioned within the housing.

41. The device of claim 34, wherein the filter is a cartridge filter.

42. The device of claim 34, further comprising mounting means for securely mounting the device, preferably wherein said mounting means comprise legs positioned on a bottom side of the housing arranged for mounting the device stably on a surface.

43. The device of any of claim 42, wherein the mounting means comprise at least one recess and/or loop arranged for receiving a strap such that the device may be hung.

44. The device of claim 34, wherein the device does not comprise pressurisation means.

45. The device of claim 34, wherein the housing further comprises a pressure regulator adapted to prevent the pressure in the device being raised above a predetermined level, preferably wherein the pressure regulator comprises a valve.

46. The device of claim 34, wherein the array of capillary fibre membranes comprises a plurality of pores having a mean size of less than 20 nanometres, preferably less than 15 nanometres.

47. The device of claim 34, wherein the fluid path comprises a secondary filter located between the filter and the output port, preferably wherein the secondary filter is a carbon filter and/or wherein the secondary filter is removable.

48. The device of claim 34, wherein at least one of the housing and output port is constructed from plastic materials, preferably at least one of water-grade acrylonitrile butadiene styrene, high-density polyethylene, medium-density polyethylene or polypropylene.

49. The device of claim 34, wherein at least the output port comprises an anti-microbial additive.

50. A water filtration system comprising:
a portable water filtration comprising:
a housing defining an interior volume, said housing comprising; an input port for receiving water under pressure from an external source, and; an output port having an open position and a closed position; wherein the device further comprises;
a filter comprising an array of hydrophilic capillary fibre membranes, said filter being positioned within the housing so as to form a fluid path between the interior volume of the housing and the output port such that, in use, when the output port is in the open position, water received at the input port flows under a pressure differential induced by the external source through walls of the capillary fibre membranes to respective open ends of the capillary fibre membranes to the output port, and further wherein;
the filter fills at least 65% of the interior volume of the housing;
an external water source, and;
connection means adapted to connect the external water source to the input port of the water filtration device such that water under pressure is provided to the water filtration device from the external water source.

51. The water filtration system of claim 50, further comprising a filter positioned between the external water source and the portable water filtration device.

52. The water filtration system of claim 50, comprising a plurality of portable water filtration devices having at least two input ports, wherein said plurality of water filtration devices are connected together by connection means such that each device is in fluid communication with the external water source and water under pressure is provided to each device from the external water source.

53. The water filtration system of claim 50, wherein the external water source is at least one of: a water harvesting tank providing a head pressure, a mains water supply, bore hole, reservoir, river and a well.
